(19) United States
(12) Patent Application Publication
(10) Pub. No.: US 2023/0405854 A1
(43) Pub. Date: Dec. 21, 2023

(54) VARIABLE PITCH, MULTIPLE ROOT BLADESET FOR HAIR CUTTING

(71) Applicant: WAHL CLIPPER CORPORATION, Sterling, IL (US)

(72) Inventors: Sam Xueyi Zhang, Sterling, IL (US); Jason William Wagner, Sterling, IL (US)

(21) Appl. No.: 17/807,078

(22) Filed: Jun. 15, 2022

(51) Int. Cl. B26B 19/38; B26B 19/06

(52) U.S. Cl. CPC B26B 19/3846; B26B 19/06

(57) ABSTRACT

A bladeset is operationally connected to a hair clipper, and includes a stationary blade and a moving blade configured for reciprocating laterally relative to the stationary blade where at least one of the stationary blade and the moving blade includes a base and a plurality of teeth extending from the base and having at least two different roots between adjacent teeth, where at least a first one of the teeth extends to a first point from the base and at least a second one of the teeth extends to a second point from the base, such that the first point and the second point are different and form two distinct cutting lines for cutting hair.

### BACKGROUND

The present invention relates generally to powered hair cutting appliances, namely hair clippers and hair trimmers, and more specifically to powered hair cutting appliances with bladesets having teeth with variable pitch and multiple roots for cutting hair at different cutting lines.

Powered hair cutting appliances, more specifically hair clippers and hair trimmers (here collectively referred to as “hair clippers”) are well known in the art, for both cutting and styling hair, and also for trimming edges of a person's hairline to achieve a relatively sharp defined edge. Such devices are used by professional hair stylists and barbers, and also by consumers to trim ones' own hair, or the hair of others.

A bladeset for hair clippers typically includes two blades, a stationary blade and a moving blade that reciprocates relative to the stationary blade. Each blade includes a plurality of forward projecting teeth that are spaced apart along a front blade edge that defines a cutting line. The spacing or distance between adjacent teeth is known as pitch. The pitch is one factor that determines how a particular bladeset cuts hair. The pitch between adjacent teeth may be the same from one end to the other end of a bladeset or it may be variable, i.e., different pitches between adjacent teeth, across the bladeset. The pitch may also be different in different blades, where the pitch between adjacent teeth of one blade in a bladeset is different from the pitch between adjacent teeth in another blade in the bladeset.

Similar to the pitch of the teeth, the alignment of the blades also affects how the bladeset cuts hair and the operation of the hair clipper. For example, fully matching the spacing between teeth of the moving and stationary blades in a bladeset provides good feeding of hair into the bladeset, but generates a high load on the motor of the hair clipper, which can cause the blade to stall and may reduce the life of the motor.

Thus, there is a need for an improved bladeset for hair clippers which enables enhanced feeding and cutting of hair.

### SUMMARY

The above-listed need is met or exceeded by the present hair clipper with a bladeset designed for enhanced cutting efficiency. In the present clipper, the bladeset includes a stationary blade and a laterally reciprocating moving blade, where the teeth on at least one of the stationary blade and the moving blade have ends or tips that form at least one cutting line for cutting hair.

In an embodiment, a bladeset is operationally connected to a hair clipper, and includes a stationary blade and a moving blade configured for reciprocating laterally relative to the stationary blade where at least one of the stationary blade and the moving blade includes a base and a plurality of teeth extending from the base and having at least two different roots between adjacent teeth, where at least a first one of the teeth extends to a first point from the base and at least a second one of the teeth extends to a second point from the base, such that the first point and the second point are different and form two distinct cutting lines for cutting hair.

In another embodiment, a hair clipper is provided and includes a clipper housing defining a longitudinal axis and a cutting end and a clipper bladeset that is operationally connected to the cutting end and includes a stationary blade and a moving blade configured for reciprocating laterally relative to the stationary blade. At least one of the stationary blade and the moving blade includes a base and a plurality of teeth extending from the base and has at least two different roots between adjacent teeth, where at least one of the teeth depends on both the first root and the second root.

In a further embodiment, a hair clipper is provided and includes a clipper housing defining a longitudinal axis and a cutting end and a clipper bladeset operationally connected to the cutting end and including a stationary blade and a moving blade configured for reciprocating laterally relative to the stationary blade. At least one of the stationary blade and the moving blade includes a base and a plurality of teeth extending from the base, where at least a first one of the teeth extends to a first point from the base, at least a second one of the teeth extends to a second point from the base and at least a third one of the teeth extends to a third point from the base, and the first point, the second point and the third point are different to form three distinct cutting lines for cutting hair.

### BRIEF DESCRIPTION OF THE DRAWINGS

FIG. 1 is a top perspective of a hair clipper including an embodiment of the present bladeset;

FIG. 2 is a top perspective view of the movable blade in the bladeset of FIG. 1.

FIG. 3 is a schematic figure showing the different cutting zones of the present bladeset.

FIG. 4 is a schematic figure showing the different cutting edges of the present bladeset.

FIG. 5A is a front perspective view of another embodiment of the movable blade of the present bladeset.

FIG. 5B is an enlarged, fragmentary view of the movable blade of FIG. 5A.

FIG. 6A is a front perspective view of a further embodiment of the movable blade of the present bladeset.

FIG. 6B is an enlarged, fragmentary view of the movable blade of FIG. 6A.

FIG. 7A is a front perspective view of the movable blade shown in FIG. 2.

FIG. 7B is an enlarged, fragmentary view of the movable blade of FIG. 7A.

FIG. 8A is a front perspective view of another embodiment of the movable blade of the present bladeset.

FIG. 8B is an enlarged, fragmentary view of the movable blade of FIG. 8A.

FIG. 9 is a front view of an embodiment of the present bladeset including partially matched teeth on the movable and stationary blades where the movable blade is in a first position.

FIG. 10 is a front view the present bladeset of FIG. 9 where the movable blade is in a second position.

FIG. 11 is a graph showing different loads on the motor of the hair clipper.

### DETAILED DESCRIPTION

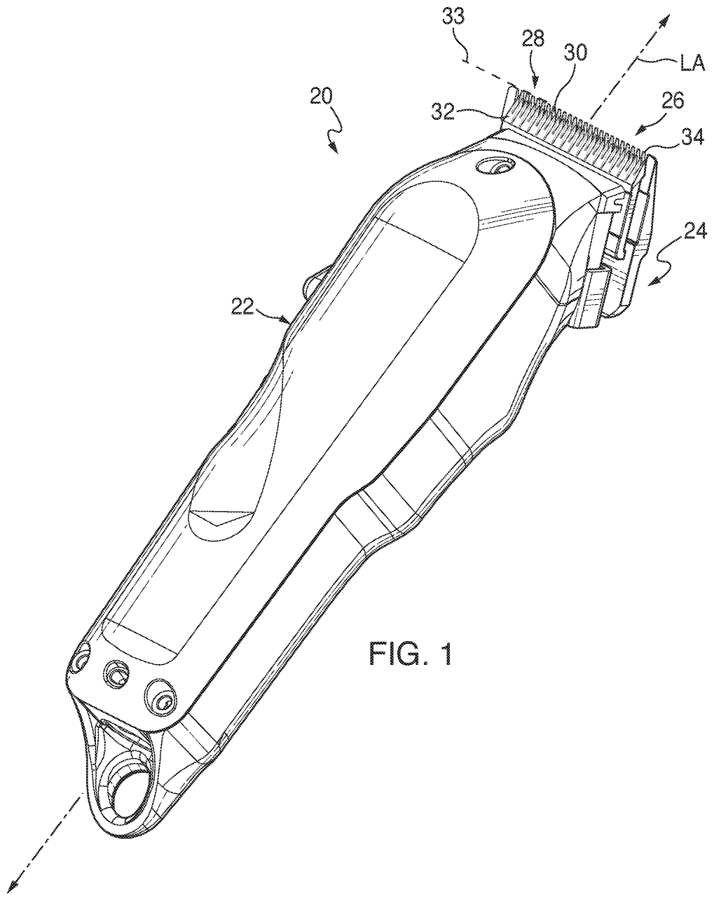

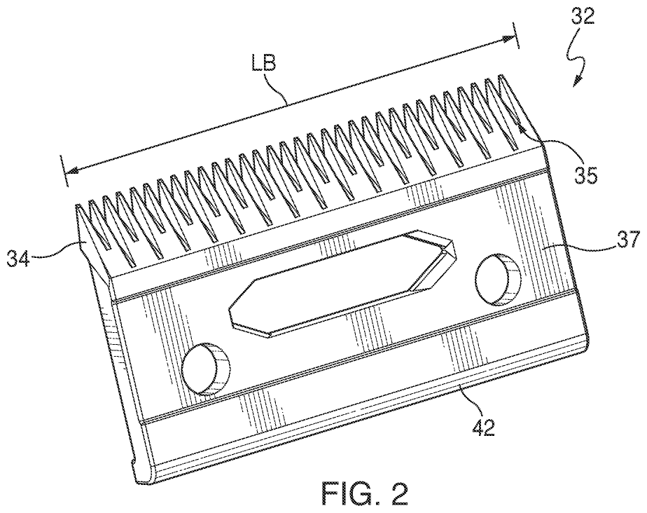

Referring to FIGS. 1-2, the present hair clipper is generally designated and includes a clipper housing 22 which encloses, among other things a drive motor, electronic circuitry, an optional rechargeable battery (all not shown), which are well known to those of ordinary skill in the art. In the preferred embodiment, the housing 22 is provided in two opposing, clamshell-like halves, as is common in the industry. The housing 22 defines a longitudinal axis “LA” (FIG. 1) and has a cutting end 24.

Included on the hair clipper 20 is a clipper bladeset 26, made up of a stationary blade 28 with a plurality of stationary blade teeth 30, and an opposing moving blade 32 having a plurality of moving blade teeth 34. A cutting line 33 is formed by the engagement of the teeth 30, 34 as the moving blade 32 is reciprocated laterally relative to the stationary blade by the drive motor and associated power transmission components. As described in detail below, the teeth 30 on the stationary blade 28 and the teeth 34 on the moving blade 32 each have a size and shape configured for cutting hair, and roots 35, that are the base of one or more of the teeth where each tooth joins the base 37 of blade. The edges of the teeth and the roots 35 define spaces 36 between the teeth. In operation, the hair being cut extends through the spaces 36 between the teeth 30, 34 on the stationary blade 28 and the moving blade 32 and is cut by the opposing cutting edges of the teeth 30, 34.

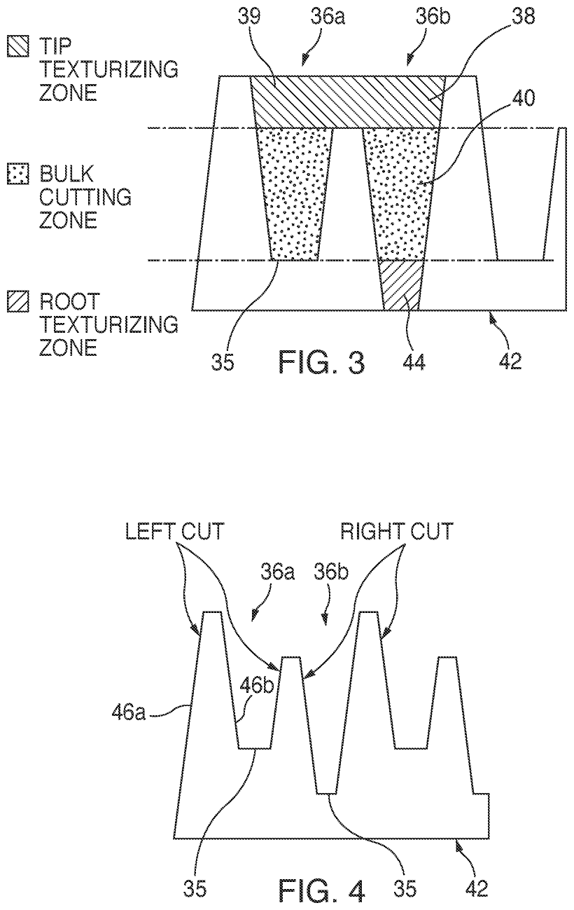

Referring to FIGS. 3-4, the size and shape of the spaces 36 between the teeth is particularly important in cutting and texturing a person's hair. As shown in FIG. 3, the spaces 36a and 36b between the teeth 30, 34 of the stationary and moving blades 28, 32 form different cutting zones. For example, an upper part 38 of each space 36a, 36b is used to create different lengths of cut in the tip texturing zone 39. The larger or wider middle part of the spaces 36a, 36b is configured to receive more hair and forms a bulk cutting zone 40. One or more of the spaces 36a, 36b may extend to the base 37 toward the mounting end 42 (FIG. 2) of the blades where the lower part of the spaces 36 creates additional differences in cut lengths and forms a root texturing zone 44. Also as shown in FIG. 4, each of the teeth 30, 34 of the stationary blade 28 and the moving blade 32 have opposing sides, left side and right side, that form cutting edges 46a and 46b to cut hair as the moving blade moves from left to right relative to the stationary blade 28. By tuning the size and shape of the above zones, a desired balance is achieved between texturizing and bulk hair cutting, where most texturizing occurs in the tip texturizing zone, while the additional root texturizing zone helps to produce a softer texturizing effect.

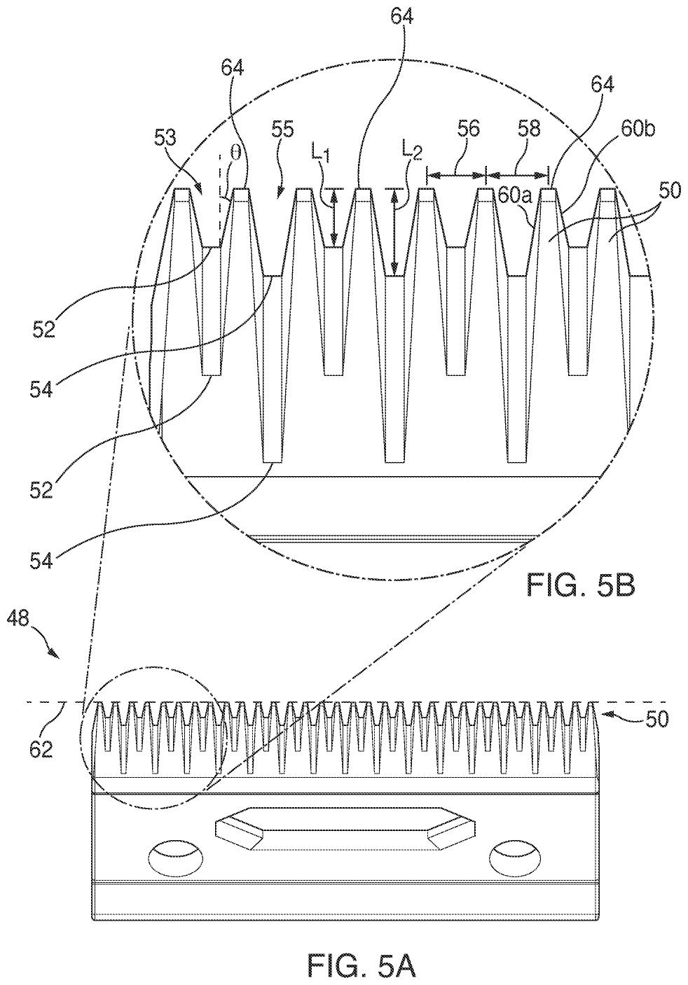

Referring to FIGS. 5A and 5B, an embodiment of a blade 48 used for the stationary blade 28 and/or the moving blade 32 of the bladeset 26 is shown where the blade 48 includes a plurality of teeth 50 extending along a length LB (FIG. 2) of the blade. In this embodiment, the teeth 50 are arranged in pairs of teeth extending from a first root 52 and defining a first space 53, and the pairs of the teeth have a second root 54 extending between the pairs of teeth and define a second space 55. The first space 53 is the space between adjacent teeth 50 in each pair, and the second space 55 is the space between the adjacent pairs of teeth. As shown in FIG. 5B, the second space 55 has a length L2 that is greater than a length L1 of the first space 53, where the length is the distance from the root at a bottom end of the first or second space to the ends of the teeth 50.

Further, the first pitch 56 between the teeth in each pair of teeth 50 is different from the second pitch 58 between adjacent pairs of teeth 50. In an example embodiment, the first pitch between the adjacent teeth in each pair of teeth is 1.219 mm and the second pitch between adjacent pairs of the teeth is 1.300 mm. It should be appreciated that the first pitch 56 and second pitch 58 may be the same, different or any suitable distance. Also in this embodiment and in the following embodiments, as described above, pitch typically refers to the lateral spacing of clipper blade teeth. In the present bladeset, the pitch is the distance from the center of one tooth to the center of an adjacent tooth. It should be appreciated that the pitch may also be the distance between a cutting edge of one tooth to the corresponding cutting edge of an adjacent tooth.

In the illustrated embodiment, each tooth 50 has a first cutting edge 60a and an opposing, second cutting edge 60b where the angle θ of each cutting edge relative to a vertical line may be the same or different. Also, the blade 48 has a single cutting line 62 that is defined by the tips or ends 64 of the teeth 50, i.e., the ends of the teeth are all in the same horizontal plane.

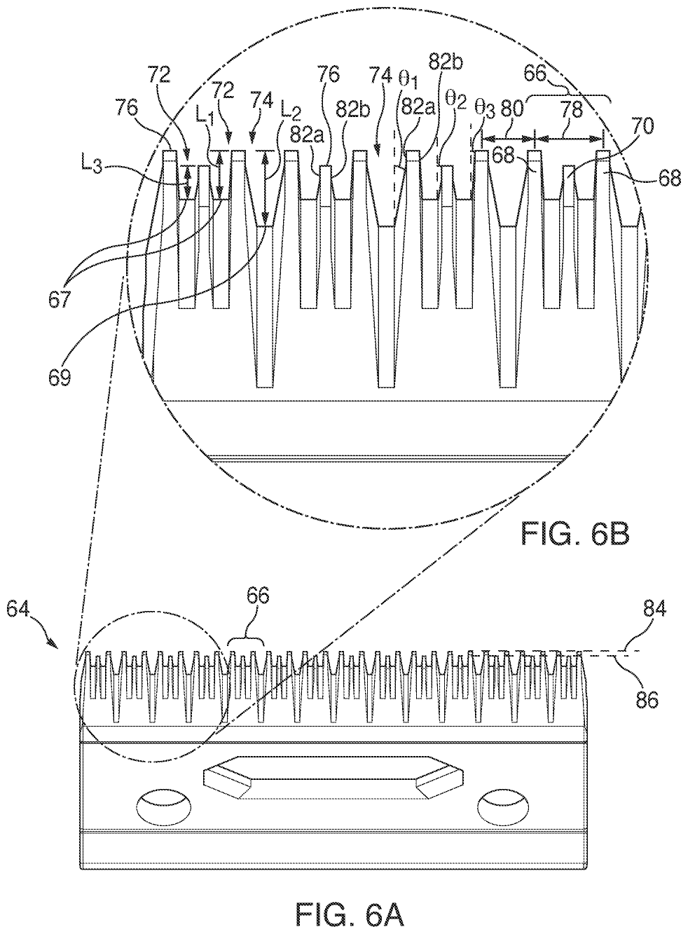

Referring to FIGS. 6A and 6B, another embodiment of a blade 65 used for the stationary blade 28 and/or the moving blade 32 of the bladeset 26 is shown where the blade includes a plurality of teeth sections 66 that extend along the length of the blade. Each of the teeth sections 66 includes three teeth extending from a first root 67 where the outer teeth 68 are on opposing sides of the teeth section and each have a length that is greater than a length of a middle tooth 70. A second root 69 extends between the teeth sections 66. Further, a first space 72, which is the space between each outer tooth 68 and the middle tooth 70, is the same in each teeth section 66. A second space 74, which is the space between adjacent teeth sections 66, is different than the first space 72. More specifically, as shown in FIG. 6B, the second space 74 has a length L2 that is greater than a length L1 of the first space 72, where the length is the distance from the first root 67 or the second root 69 to the ends 76 of the outer teeth 68.

Also in this embodiment, a first pitch 78, which is the distance between the outer teeth 68 in each teeth section 66, is different than a second pitch 80, which is the distance between adjacent teeth sections 66. In an example embodiment, the first pitch is 1.626 mm and the second pitch is 1.255 mm. It should be appreciated that the first pitch and second pitch may be the same, different or any suitable distance. Each of the teeth 68, 70 in this embodiment have a first cutting edge 82a and an opposing, second cutting edge 82b where the angle θ of each cutting edge relative to a vertical line may be the same or different. As shown in FIG. 6B, the angles θ1, θ2 and θ3 of the opposing first and second cutting edges of the teeth 68, 70 are different. This configuration enables the teeth 68, 70 within each section 66 and between the sections to cut hair at different lengths, such as for different texturing.

In the illustrated embodiment, the ends 76 of the outer teeth 68 extend further outwardly from the blade 64 than the ends 76 of the middle teeth 70 in each of the teeth sections 66. In this way, the blade 64 has two different cutting lines, namely, a first cutting line 84 formed by the ends 76 of the outer teeth 68, and a second cutting line 86 formed by the ends 76 of the middle teeth 70 as shown in FIG. 6A where hair is cut at either the first cutting line or the second cutting line.

Furthermore as shown in FIG. 6B, the first root 67 defines a first root line that is transverse to the longitudinal axis of the clipper housing and the second root 69 defines a second root line where the distance between the first root relative to the ends of teeth 76 is different than the distance between the second root and the ends of the teeth 76. In this embodiment, some teeth, such as teeth 76, extend solely from the first root 67 (first root line) and some teeth extend from both the first root 67 (first root line) and the second root 69 (second root line), such as teeth 68. It should be appreciated that the blades in the bladeset may have any suitable number of roots, where the teeth extend from one root or two roots.

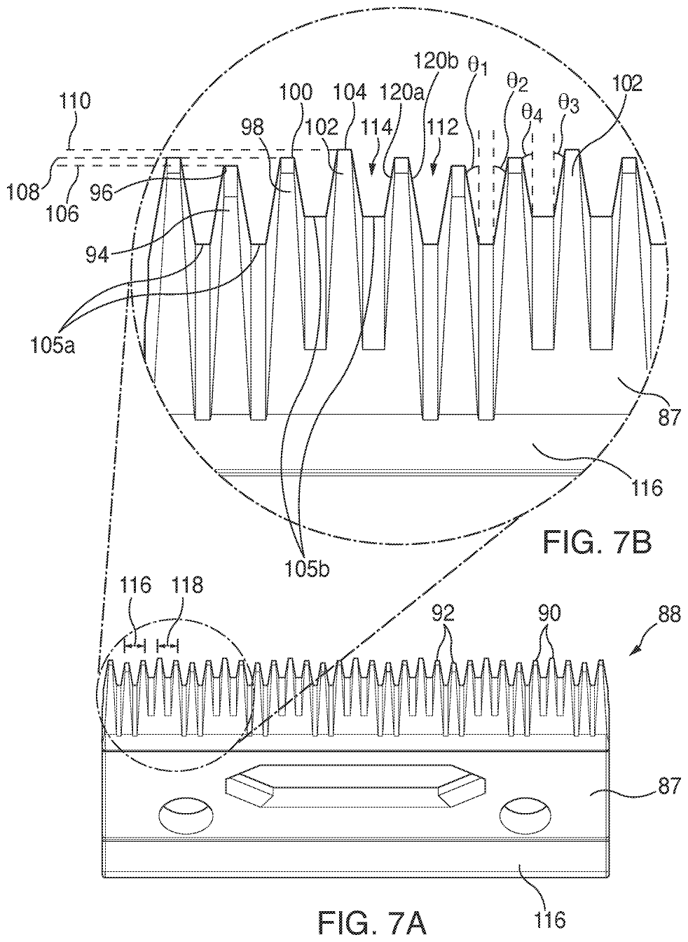

Referring now to FIGS. 7A and 7B, another embodiment of a blade 88 used for the stationary blade 28 and/or the moving blade 32 of the bladeset 26 is shown where the blade 88 includes a plurality of teeth 90 having ends 92 that extend to different points outwardly from the blade, and different roots extending between adjacent teeth to form a wave pattern that extends along the length of the blade. More specifically, the teeth 90 on the blade 88 include first teeth 94 with first ends 96 that extend outwardly to a first point from the blade, second teeth 98 with second ends 100 that extend outwardly to a second point from the blade and third teeth 102 with third ends 104 that extend outwardly to a third point from the blade 88. In this embodiment, the ends 104 of the third teeth 102 extend further from the base 87 of the blade 88 than the ends 100 of the second teeth 98, which extend further from the base 87 than the ends 96 of the first teeth 94. As shown in FIG. 7B, the ends 96 of the first teeth 94 define a first cutting line 106, the ends 100 of the second teeth 98 define a second cutting line 108 and the ends 96 of the third teeth 94 define a third cutting line 110.

The teeth 90 also extend from a first root 105a and a second root 105b and define two different spaces between the teeth, a first space 112 located between a first tooth 94 and an adjacent second tooth 98, and a second space 114 located between a second tooth 98 and an adjacent third tooth 102. As shown in FIG. 7B, the second space 114 extends closer to a mounting end 116 of the base 87 than the first space 112. It should be appreciated that the first space 112 and the second space 114 may be the same, i.e., same size and shape, or different.

Also in this embodiment, the plurality of teeth 90 have a first pitch 116, which is the distance between adjacent first teeth 94 and second teeth 98, and a second pitch 118, which is the distance between adjacent second teeth 98 and third teeth 102. In an embodiment, the first pitch 116 and the second pitch 118 are the same. In another embodiment, the first pitch 116 and the second pitch 118 are different. It should be appreciated that the first pitch 116 and second pitch 118 may be the same, different or any suitable distance. Further, each of the teeth 90 in this embodiment have a first cutting edge 120a and an opposing, second cutting edge 120b where the angle θ of each cutting edge relative to a vertical line may be the same or different. As shown in FIG. 7B, the angles θ1, θ2, θ3 and θ4 of the opposing first and second cutting edges 120a, 120b of the first, second and third teeth 94, 98, 102 are different.

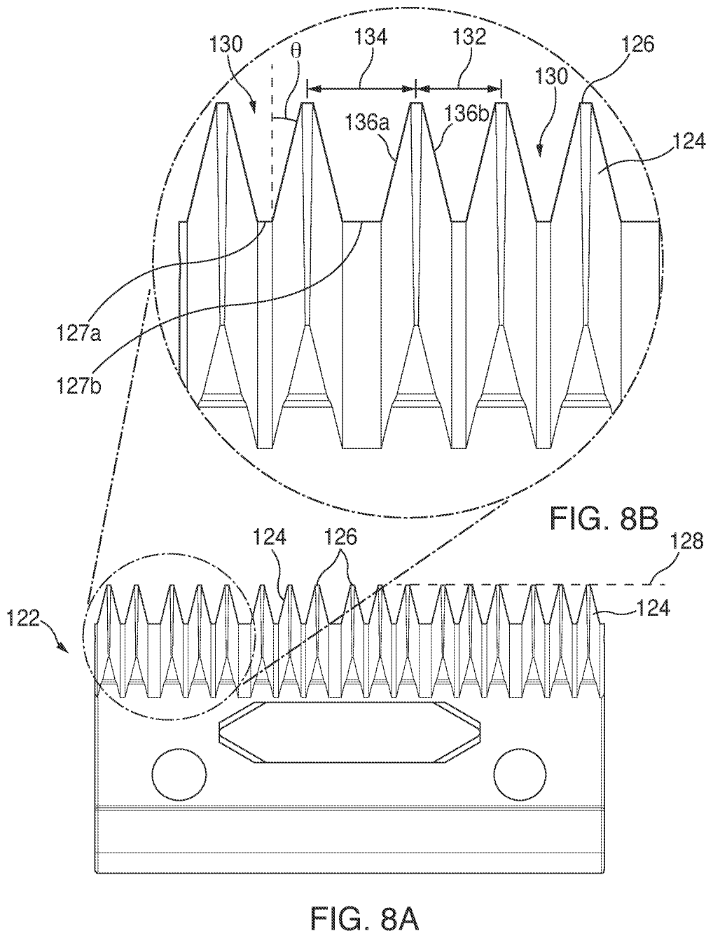

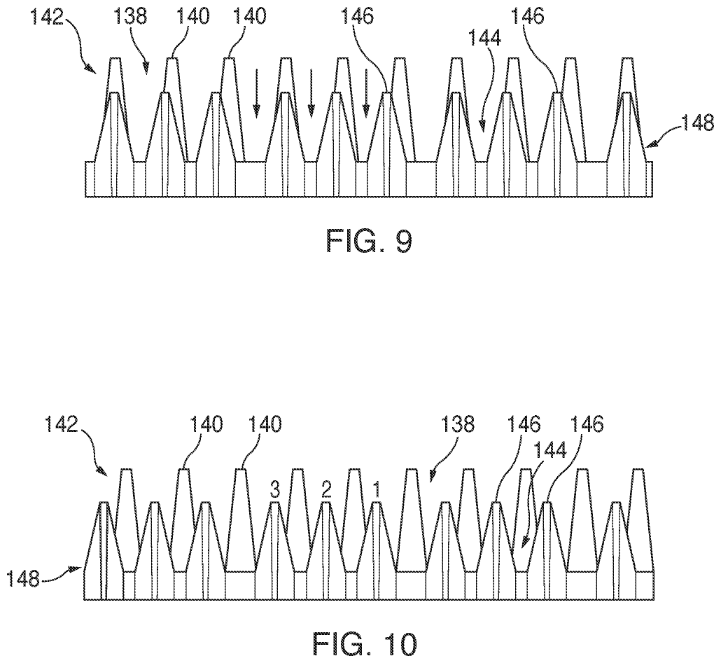

Referring to FIGS. 8A and 8B, a further embodiment of a blade 122 used for the stationary blade 28 and/or the moving blade 32 of the bladeset 26 is shown where the blade 122 includes a plurality of teeth 124 having ends 126 that extend from a first root 127a or second root 127b to a common point or same point outwardly from the blade 122 to form a single cutting line 128. Also, there is a plurality of spaces 130 between adjacent teeth 124 along the length of the blade 122, where the spaces are different or the same, i.e., same size and shape. In this embodiment, the pitch between adjacent teeth 124 is different. Specifically as shown in FIG. 8B, in an example embodiment, the teeth include a first pitch 132 between adjacent teeth 124 and a second pitch 134 between adjacent teeth 124. In an example embodiment, the first pitch is 2.184 mm and the second pitch is 2.794 mm. It should be appreciated that the first pitch 132 and the second pitch 134 may be the same, different or any suitable distance. The two distinct pitches, the first pitch 132 and the second pitch 134, repeat along the length of the blade.

Additionally, each of the teeth 124 in this embodiment have a first cutting edge 136a and an opposing, second cutting edge 136b where the angle θ of each cutting edge relative to a vertical line is the same. In another embodiment, the angle of the cutting edges 136a, 136b of the teeth 124 are different. It should be appreciated that one or more of the teeth 124 of the blade 122 may have cutting edges with an angle θ that are the same or different.

In an embodiment, the spaces between teeth of a stationary blade and the spaces between teeth in a moving blade exactly match such that the teeth on the stationary blade and the moving blade are substantially aligned with each other. In another embodiment shown in FIGS. 9-11, the spaces 138 between teeth 140 on a stationary blade 142 partially match spaces 144 between teeth 146 on a moving blade 148. In this way, the teeth 146 on the moving blade 148 at least partially extend into (or overlap) the spaces 138 between the teeth 140 on the stationary blade 142 when the moving blade 148 reciprocates relative to the stationary blade 142. As a result, this configuration enhances feeding of hair through the blades 142, 148 because the spaces between all of the teeth are generally open at the same time. In addition, this configuration also reduces the maximum load and/or the duration of the maximum load on the motor because all of the teeth are not cutting hair at the same time, which in turn, improves the life of the clipper motor.

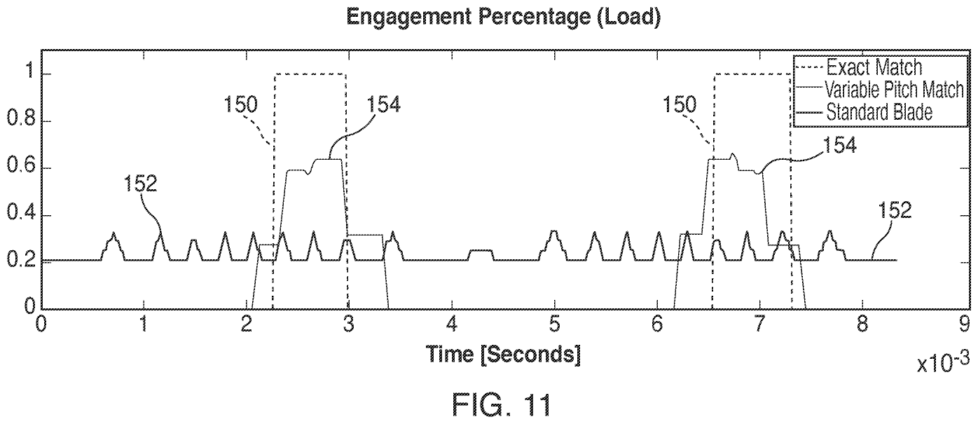

FIG. 11 shows a graph having engagement percentage, i.e., the percent of the teeth of the bladeset that engage hair at the same time, on the Y-axis and time on the X-axis. As shown in FIG. 11, when the teeth on the stationary blade and the moving blade are fully or exactly matched, there is enhanced feeding of hair to the bladeset while the load 150 on the motor is high because all of the teeth are cutting hair at the same time. In a conventional or standard bladeset, the percentage of engagement is low, which keeps the load 152 on the motor low but feeding of hair into the teeth is sometimes obstructed. By comparison, partially matching the blades reduces the load 154 on the motor because all of the teeth are not cutting at the exact same angle and at the exact same time. Also similar to the exact match configuration, there is a spike in the motor load 154 of the partially matched blades, but it is significantly less than the load 150 produced by the exactly matched blades, and is spread out over a longer period of time. In the above embodiments, the teeth on the stationary blade and the moving blade may be exactly matched or partially matched with each other.

While a particular embodiments of the present hair clipper and associated bladeset have been described herein, it will be appreciated by those skilled in the art that changes and modifications may be made thereto without departing from the invention in its broader aspects and as set forth in the following claims.

1. A bladeset operationally connected to a hair clipper, the bladeset comprising:
a stationary blade and a moving blade configured for reciprocating laterally relative to said stationary blade;
at least one of said stationary blade and said moving blade including a base and a plurality of teeth extending from said base and having at least two different roots between adjacent teeth, wherein at least a first one of the teeth extends to a first point from said base and at least a second one of the teeth extends to a second point from said base, wherein said first point and said second point are different and form two distinct cutting lines for cutting hair.

2. The bladeset of claim 1, wherein each of said teeth include a first cutting edge and a second cutting edge, said first cutting edge and said second cutting edge each forming an angle relative to a vertical line extending transversely from said base, wherein the angles of the first cutting edge and the second cutting edge of at least two of the teeth are different.

3. The bladeset of claim 1, wherein each of said teeth include a first cutting edge and a second cutting edge, said first cutting edge and said second cutting edge each forming an angle relative to a vertical line extending transversely from said base, wherein the angles of the first cutting edge and the second cutting edge of all of the teeth are the same.

4. The bladeset of claim 1, wherein each of said teeth include a first cutting edge and a second cutting edge, said first cutting edge and said second cutting edge each forming an angle relative to a vertical line extending transversely from said base, wherein the angle of the first cutting edge and the angle of the second cutting edge of at least one of the teeth are different.

5. The bladeset of claim 1, wherein each of said teeth include a first cutting edge and a second cutting edge, said first cutting edge and said second cutting edge each forming an angle relative to a vertical line extending transversely from said base, wherein the angle of the first cutting edge and the angle of the second cutting edge of a plurality of the teeth are different.

6. The bladeset of claim 1, wherein the teeth are formed as teeth sections, each of said sections including at least two teeth, wherein said at least two teeth in each of said teeth sections has a first pitch, and adjacent teeth between the teeth sections has a second pitch, wherein said first pitch and said section pitch are different.

7. The bladeset of claim 1, wherein the teeth are formed as teeth sections, each of said sections including at least two teeth, wherein said at least two teeth in each of said teeth sections has a first pitch, and adjacent teeth between the teeth sections has a second pitch, wherein said first pitch and said section pitch are the same.

8. The bladeset of claim 1, wherein the teeth each have a flat end and the flat ends of the teeth are parallel to each other.

9. A hair clipper comprising:
a clipper housing defining a longitudinal axis and a cutting end; and
a clipper bladeset operationally connected to said cutting end and including a stationary blade and a moving blade configured for reciprocating laterally relative to said stationary blade;
at least one of said stationary blade and said moving blade including a base and a plurality of teeth extending from said base and having at least two different roots between adjacent teeth, wherein at least one of said teeth depends on both the first root and the second root.

10. The hair clipper of claim 9, wherein each of said teeth include a first cutting edge and a second cutting edge, said first cutting edge and said second cutting edge each forming an angle relative to a vertical line extending transversely from said base, wherein the angles of the first cutting edge and the second cutting edge of at least two of the teeth are different.

11. The hair clipper of claim 9, wherein each of said teeth include a first cutting edge and a second cutting edge, said first cutting edge and said second cutting edge each forming an angle relative to a vertical line extending transversely from said base, wherein the angles of the first cutting edge and the second cutting edge of all of the teeth are the same.

12. The hair clipper of claim 9, wherein each of said teeth include a first cutting edge and a second cutting edge, said first cutting edge and said second cutting edge each forming an angle relative to a vertical line extending transversely from said base, wherein the angle of the first cutting edge and the angle of the second cutting edge of at least one of the teeth are different.

13. The hair clipper of claim 9, wherein each of said teeth include a first cutting edge and a second cutting edge, said first cutting edge and said second cutting edge each forming an angle relative to a vertical line extending transversely from said base, wherein the angle of the first cutting edge and the angle of the second cutting edge of a plurality of the teeth are different.

14. The hair clipper of claim 9, wherein the teeth are formed as teeth sections, each of said sections including at least two teeth, wherein said at least two teeth in each of said teeth sections has a first pitch, and adjacent teeth between the teeth sections has a second pitch, wherein said first pitch and said section pitch are different.

15. The hair clipper of claim 9, wherein the teeth are formed as teeth sections, each of said sections including at least two teeth, wherein said at least two teeth in each of said teeth sections has a first pitch, and adjacent teeth between the teeth sections has a second pitch, wherein said first pitch and said section pitch are the same.

16. A hair clipper comprising:
a clipper housing defining a longitudinal axis and a cutting end; and
a clipper bladeset operationally connected to said cutting end and including a stationary blade and a moving blade configured for reciprocating laterally relative to said stationary blade;
at least one of said stationary blade and said moving blade including a base and a plurality of teeth extending from said base, wherein at least a first one of the teeth extends to a first point from said base, at least a second one of the teeth extends to a second point from said base and at least a third one of the teeth extends to a third point from said base, wherein said first point, said second point and said third point are different and form three distinct cutting lines for cutting hair.

17. The hair clipper of claim 16, wherein the teeth define at least two different roots.

18. The hair clipper of claim 16, wherein each of said teeth include a first cutting edge and a second cutting edge, said first cutting edge and said second cutting edge each forming an angle relative to a vertical line extending transversely from said base, wherein the angles of the first cutting edge and the second cutting edge of at least two of the teeth are different.

19. The hair clipper of claim 16, wherein each of said teeth include a first cutting edge and a second cutting edge, said first cutting edge and said second cutting edge each forming an angle relative to a vertical line extending transversely from said base, wherein the angles of the first cutting edge and the second cutting edge of all of the teeth are the same.

20. The hair clipper of claim 16, wherein each of said teeth include a first cutting edge and a second cutting edge, said first cutting edge and said second cutting edge each forming an angle relative to a vertical line extending transversely from said base, wherein the angle of the first cutting edge and the angle of the second cutting edge of at least one of the teeth are different.

21. The hair clipper of claim 16, wherein each of said teeth include a first cutting edge and a second cutting edge, said first cutting edge and said second cutting edge each forming an angle relative to a vertical line extending transversely from said base, wherein the angle of the first cutting edge and the angle of the second cutting edge of a plurality of the teeth are different.

22. The hair clipper of claim 16, wherein at least two adjacent teeth have a first pitch and another two adjacent teeth have a second pitch, wherein the first pitch and the second pitch are different.

23. The hair clipper of claim 16, wherein at least two adjacent teeth have a first pitch and another two adjacent teeth have a second pitch, wherein the first pitch and the second pitch are the same.

24. The hair clipper of claim 16, wherein the teeth each have a flat end and the flat ends of the teeth are parallel to each other.
